(19) United States
(12) Patent Application Publication
(10) Pub. No.: US 2025/0117029 A1
(43) Pub. Date: Apr. 10, 2025

(54) AUTOMATIC MULTI-MODALITY SENSOR CALIBRATION WITH NEAR-INFRARED IMAGES

(71) Applicant: NEC Laboratories America, Inc., Princeton, NJ (US)

(72) Inventors: Tom Bu, San Jose, CA (US); Bingbing Zhuang, Santa Clara, CA (US); Manmohan Chandraker, Santa Clara, CA (US)

(21) Appl. No.: 18/905,280

(22) Filed: Oct. 3, 2024

Related U.S. Application Data
(60) Provisional application No. 63/542,405, filed on Oct. 4, 2023.

(51) Int. Cl. G05D 1/86; G05D 1/242; G05D 1/243; G05D 107/60; G05D 111/67

(52) U.S. Cl. CPC G05D 1/86; G05D 1/242; G05D 1/2435; G05D 2107/65; G05D 2111/67

(57) ABSTRACT

Systems and methods for automatic multi-modality sensor calibration with near-infrared images (NIR). Image keypoints from collected images and NIR keypoints from NIR can be detected. A deep-learning-based neural network that learns relation graphs between the image keypoints and the NIR keypoints can match the image keypoints and the NIR keypoints. Three dimensional (3D) points from 3D point cloud data can be filtered based on corresponding 3D points from the NIR keypoints (NIR-to-3D points) to obtain filtered NIR-to-3D points. An extrinsic calibration can be optimized based on a reprojection error computed from the filtered NIR-to-3D points to obtain an optimized extrinsic calibration for an autonomous entity control system. An entity can be controlled by employing the optimized extrinsic calibration for the autonomous entity control system.

### RELATED APPLICATION INFORMATION

This application claims priority to U.S. Provisional App. No. 63/542,405 filed on Oct. 4, 2023, incorporated herein by reference in its entirety.

### BACKGROUND

### Technical Field

The present invention relates to scene understanding and reconstruction with artificial intelligence, and more particularly to automatic multi-modality sensor calibration with near-infrared images.

### Description of the Related Art

LiDAR and camera sensors are used in 3D scene understanding and reconstruction. Light Detection and Ranging (LiDAR) sensors can capture three dimensional (3D) structural information of an environment. A camera can capture color, texture, and appearance of an environment. Both modalities have different dimensions and to take advantage of both modalities, an accurate representation that aligns LiDAR outputs and the camera outputs is necessary.

### SUMMARY

According to an aspect of the present invention, a computer-implemented method is provided for automatic multi-modality sensor calibration with near-infrared images (NIR), including detecting image keypoints from collected images and NIR keypoints from NIR, matching the image keypoints and the NIR keypoints using a deep-learning-based neural network that learns relation graphs between the image keypoints and the NIR keypoints, filtering three dimensional (3D) points from 3D point cloud data based on corresponding 3D points from the NIR keypoints (NIR-to-3D points) to obtain filtered NIR-to-3D points, optimizing an extrinsic calibration based on a reprojection error computed from the filtered NIR-to-3D points to obtain an optimized extrinsic calibration for an autonomous entity control system, and controlling an entity by employing the optimized extrinsic calibration for the autonomous entity control system.

According to another aspect of the present invention, a system for automatic multi-modality sensor calibration with near-infrared images (NIR) is provided, including, a memory device, one or more processor devices operatively coupled with the memory device to, detect image keypoints from collected images and NIR keypoints from NIR, match the image keypoints and the NIR keypoints using a deep-learning-based neural network that learns relation graphs between the image keypoints and the NIR keypoints, filter three dimensional (3D) points from 3D point cloud data based on corresponding 3D points from the NIR keypoints (NIR-to-3D points) to obtain filtered NIR-to-3D points, optimize an extrinsic calibration based on a reprojection error computed from the filtered NIR-to-3D points to obtain an optimized extrinsic calibration for an autonomous entity control system, and control an entity by employing the optimized extrinsic calibration for the autonomous entity control system.

According to yet another aspect of the present invention, a non-transitory computer program product is provided including a computer-readable storage medium having program code for automatic multi-modality sensor calibration with near infrared images (NIR), wherein the program code when executed on a computer causes the computer to detect image keypoints from collected images and NIR keypoints from NIR, match the image keypoints and the NIR keypoints using a deep-learning-based neural network that learns relation graphs between the image keypoints and the NIR keypoints, filter three dimensional (3D) points from 3D point cloud data based on corresponding 3D points from the NIR keypoints (NIR-to-3D points) to obtain filtered NIR-to-3D points, optimize an extrinsic calibration based on a reprojection error computed from the filtered NIR-to-3D points to obtain an optimized extrinsic calibration for an autonomous entity control system, and control an entity by employing the optimized extrinsic calibration for the autonomous entity control system.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of computer-implemented method for automatic multi-modality sensor calibration with near infrared images, in accordance with an embodiment of the present invention;

FIG. 2 is a block diagram illustrating a hardware system for automatic multi-modality sensor calibration with near infrared images, in accordance with an embodiment of the present invention;

FIG. 3 is a block diagram illustrating a system including hardware and software components for automatic multi-modality sensor calibration with near infrared images, in accordance with an embodiment of the present invention;

FIG. 4 is a block diagram illustrating practical applications for automatic multi-modality sensor calibration with near infrared images, in accordance with an embodiment of the present invention; and

FIG. 5 is a block diagram illustrating deep learning neural networks for automatic multi-modality sensor calibration with near infrared images, in accordance with an embodiment of the present invention.

### DETAILED DESCRIPTION OF PREFERRED EMBODIMENTS

In accordance with embodiments of the present invention, systems and methods are provided for automatic multi-modality sensor calibration with near-infrared images. In an embodiment, a method for automatic multi-modality sensor calibration with

near-infrared images (NIR) can obtain an extrinsic calibration for an autonomous entity control system. To obtain the extrinsic calibration, a convolutional neural network can detect image keypoints from collected images and NIR keypoints from NIR. A deep-learning-based neural network that learns relation graphs between the image keypoints and the NIR keypoints can match the image keypoints and the NIR keypoints. Three dimensional (3D) points from 3D point cloud data can be filtered based on corresponding 3D points from the NIR keypoints (NIR-to-3D points) to obtain filtered NIR-to-3D points. An extrinsic calibration can be optimized based on a reprojection error computed from the filtered NIR-to-3D points to obtain an optimized extrinsic calibration for an autonomous entity control system. An entity can be controlled by employing the extrinsic calibration for the autonomous entity control system.

Light detection and ranging (LiDAR) sensors and cameras are commonly used together for 3D scene understanding and reconstruction in applications such as autonomous driving, robotics, and navigation. While a LiDAR sensor captures the 3D structural information of an environment, a camera captures color, texture, and appearance data. However, because the LiDAR sensor and camera each capture data in their own coordinate systems, LiDAR-camera calibration involves estimating the relative rotation and translation, known as the extrinsic matrix (e.g., extrinsic calibration), which aligns the data from a LiDAR sensor and a camera into the same coordinate system.

Traditional methods use planar boards with checkerboard patterns to establish 2D and 3D correspondences. However, this approach requires manual setup of planar boards in different positions and orientations each time the system needs calibration. Furthermore, identifying LiDAR points on the planar board is often a manual and error-prone process. This makes it difficult to deploy on self-driving vehicles or advanced driver assistance system (ADAS) at scale, even with a one-time offline calibration per vehicle.

In addition, it is inevitable that the mounting of sensors drifts from their initial setup gradually over time, e.g., due to vibrations of vehicles. Thus, constant online calibration is required to compensate for such deviations in order to maintain the best performance. The challenge with this problem lies in the lack of direct point correspondences between camera and LiDAR.

In camera-camera calibration, it is the golden standard to establish pixel correspondences as the essential first step, as they induce multi-view projective geometry constraints that serve as direct and strong cues for solving the extrinsic parameters. However, due to the different capture nature of camera and LiDAR, (e.g., dense 2D pixels versus sparse 3D point clouds) it is non-trivial to establish such 2D-3D correspondences. Hence, existing automatic calibration methods typically leverage the rigidity constraint—the relative pose between camera and LiDAR does not change during the calibration period, and perform extrinsic calibration through the alignment between two trajectories from image and LiDAR. However, this line of approaches is not robust as it relies on the accuracy of Simultaneous Localization and Mapping (SLAM), which nevertheless suffers from various challenges such as drift.

In contrast, the present embodiments present a new method for LiDAR-camera calibration based on direct 2D-3D correspondences. The present embodiments can leverage near-infrared images observed from the LiDAR as a bridge to establish 2D and 2D correspondences between camera and LiDAR point clouds. The present embodiments can utilize the near-infrared image (NIR) from the LiDAR for keypoint detection and matching with camera images. Since the two data modalities (e.g., NIR and 3D point cloud from LiDAR) are closely related, correspondences can be more easily identified compared to relying solely on the geometric information from LiDAR point cloud. The present embodiments then leverage the association between near-infrared image and LiDAR point cloud to establish 2D-3D correspondence, whereby the extrinsic calibration can then be estimated using perspective-n-point (PnP) optimization.

The present embodiments can establish an automated camera-LiDAR calibration framework that operates seamlessly with everyday driving data, proficiently estimating the extrinsic calibration parameters for multiple configurations including a single LiDAR sensor and six surround-view cameras without additional setup. Utilizing near-infrared image (NIR) captured by LiDAR to facilitate 2D-3D correspondences between the camera and LiDAR obviates the need for manual efforts in identifying correspondences, as well as the need for calibration targets such as checkboards. As such, the correspondences are also diverse as it can be any matched points in the scene. The inclusion of diverse correspondences in the optimization process improves overall robustness of the present embodiments over other calibration methods. Furthermore, its automatic nature enables real-time online calibration through streaming data obtained from input sensors, a capability not achievable with target-based checkerboard calibration methods.

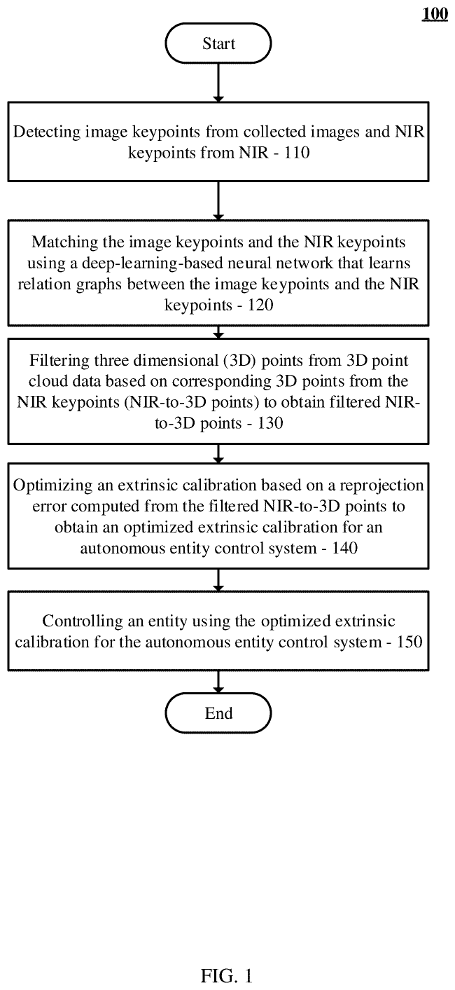

Referring now in detail to the figures in which like numerals represent the same or similar elements and initially to FIG. 1, a high-level overview of a computer-implemented method for automatic multi-modality sensor calibration with near-infrared images is illustratively depicted in accordance with one embodiment of the present invention.

In an embodiment, a method for automatic multi-modality sensor calibration with near-infrared images (NIR) can obtain an extrinsic calibration for an autonomous entity control system 300. To obtain the extrinsic calibration, a convolutional neural network can detect image keypoints from collected images and NIR keypoints from NIR. A deep-learning-based neural network that learns relation graphs between the image keypoints and the NIR keypoints can match the image keypoints and the NIR keypoints. Three dimensional (3D) points from 3D point cloud data can be filtered based on corresponding 3D points from the NIR keypoints (NIR-to-3D points) to obtain filtered NIR-to-3D points. An extrinsic calibration can be optimized based on a reprojection error computed from the filtered NIR-to-3D points to obtain an optimized extrinsic calibration for an autonomous entity control system. An entity can be controlled by employing the extrinsic calibration for the autonomous entity control system.

Referring now to block 110 of FIG. 1 that describes an embodiment of a method where a convolutional neural network can detect image keypoints from collected images and NIR keypoints from NIR.

Collected image data from cameras can be represented in a two-dimensional (2D) pixel space. Image keypoints (e.g., points of interest) can be obtained from the collected image data by using a keypoint detection model. For example, a keypoint for an image of a dog can include points of the outline of the dog.

NIR can be obtained from light detection and ranging (LiDAR) sensors (e.g., Ouster®) which can also be represented in a 2D pixel space. NIR keypoints can be obtained from NIR by using the keypoint detection model.

In an embodiment, the keypoint detection model can employ a convolutional neural network that can detect keypoints from input images and extract descriptors of the detected keypoints. The descriptors can be vectors that encode information (e.g., position, coordinate points, color statistics, etc.) that represent the appearance of a local region around each keypoint. The keypoint detection model can utilize a keypoint detection algorithm such as self-supervised keypoint detection and descriptor algorithm (SuperPoint). The keypoint detection model can employ a heatmap that represents the probability of a keypoint being present at each pixel location.

Other keypoint detection and descriptor algorithms can be employed such as scale-invariant feature transform (SIFT), oriented features from accelerated segment test and rotated binary robust independent elementary features (ORB), or speeded up robust features (SURF).

Referring now to block 120 of FIG. 1 that describes an embodiment of a method where a deep-learning-based neural network that learns relation graphs between the image keypoints and the NIR keypoints can match the image keypoints and the NIR keypoints.

The deep-learning-based neural network (DLBNN) can employ keypoint matching model such as learning feature mapping with graph neural networks (SuperGlue). The DLBNN can take keypoints and their corresponding descriptors from input images and learn correspondences between the input images using attention mechanisms and graph neural networks to match the keypoints from the input images.

The DLBNN can represent keypoints of the input images as nodes in a relation graph where edges between nodes encode relationships between the keypoints. The relation graphs can be iteratively updated by considering descriptor similarity and spatial relationships between keypoints. The DLBNN can employ attention to focus on the most relevant keypoints and descriptors. For example, a keypoint located within the outline of a dog can be given higher priority over a keypoint located within an obscured area of the image such as shadows.

Referring now to block 130 of FIG. 1 that describes an embodiment of a method where three dimensional (3D) points can be filtered from 3D point cloud data based on corresponding 3D points from the NIR keypoints (NIR-to-3D) to obtain filtered NIR-to-3D keypoints.

LiDAR sensors can output 3D point cloud data as a range image. The NIR and the 3D point cloud can be easily aligned as correspondence between the two data can be readily obtained by comparing their pixel location. The pixel location can be the same pixel coordinate that can be paired as a pair of correspondence. To interpolate 3D points from 2D points of the NIR keypoints, the range image based on the sub-pixel key points can be interpolated on the NIR to obtain an interpolated range. The 2D points of the NIR keypoints can be approximated into a 3D point using the interpolated range through bilinear interpolation. To filter the 3D points with the NIR keypoints, NIR keypoints without corresponding 3D points are removed, and retaining NIR keypoints with corresponding 3D points to obtain filtered NIR-to-3D points.

Referring now to block 140 of FIG. 1 that describes an embodiment of a method where the extrinsic calibration can be optimized based on a reprojection error computed from the filtered NIR-to-3D points to obtain an optimized extrinsic calibration for an autonomous entity control system.

To optimize the extrinsic calibration of the LiDAR and camera sensors and obtain optimized extrinsic calibration, a reprojection error between projections to the image plane and their corresponding image keypoints can be minimized. The extrinsic calibration can include parameters that can refer to rotation and translation.

To compute the reprojection error, the 3D points from the filtered NIR-to-3D points can be projected onto the camera image plane using the extrinsic calibration parameters and the known camera intrinsics, and then measure the distance to corresponding keypoints detected from the camera image. The reprojection error can be the Euclidean distance between an observed point from the filtered NIR-to-3D points and a reprojected point. A reprojected point can be generated by using 2D points from the filtered NIR-to-3D points and an estimated camera pose computed using the PnP module. The optimized extrinsic calibration can include an extrinsic calibration having the highest number of data points between 3D points and two-dimensional (2D) points which can be determined iteratively until a threshold has been met. The threshold can be a natural number (e.g. five, ten, etc.).

Referring now to block 150 of FIG. 1 that describes an embodiment of a method where an entity can be controlled using the optimized extrinsic calibration for the autonomous entity control system.

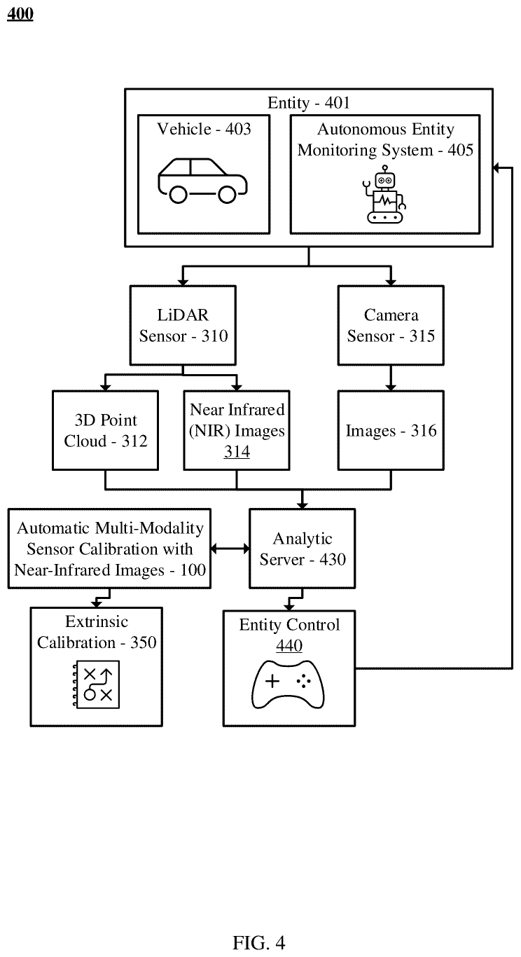

In an embodiment, the optimized extrinsic calibration can be utilized by an entity (e.g., vehicle, robot, drone, etc.) for 3D scene understanding and reconstruction which in turn, can be used in autonomous driving, robotics, navigation, scene modeling, etc. Practical applications for the extrinsic calibration are shown in FIG. 4.

Referring now to FIG. 4, where practical applications for the automatic multi-modality sensor calibration with near-infrared images are shown, in accordance with an embodiment of the present invention.

In an embodiment, the entity 401 (e.g., vehicle, drone, etc.) can include the LiDAR sensor 410 and camera sensor 415 which can collect input data 3D point cloud 412 and near infrared images (NIR) 414, and images 416, respectively, in a streaming manner and an extrinsic calibration 350 can be generated by an analytic server 430 included within the entity 401.

In another embodiment, the LiDAR sensor 410 and camera sensor 415 can be placed on a fixed location, separate from the entity, where the entity 401 can be observed. In another embodiment, the analytic server 430 can be placed in a different location and the 3D point cloud 412, near infrared images (NIR) 414, and images 416, can be sent over through a network. The analytic server 430 can implement the automatic multi-modality sensor calibration with near-infrared images 100 to generate an entity control 440 based on the extrinsic calibration.

In an embodiment, an autonomous patient monitoring system 405 (e.g., robot, drone, camera system, etc.) can be controlled with an entity control 440 based on the extrinsic calibration 350 to monitor monitored entities (e.g., patients, healthcare professionals) within a hospital ward. The entity control 440 can include instructions to the controlling mechanism to perform an action (e.g., moving, dispensing medicine, etc.). The autonomous patient monitoring system 405 can assist with the decision-making process (e.g., updating medical diagnosis, updating medical treatment, etc.) of a decision-making entity (e.g., healthcare professionals).

In another embodiment, a vehicle 403 can be controlled by the entity control 440 based on the extrinsic calibration 350. The entity control 440 can include instructions to the controlling mechanism to perform an action (e.g., steering, changing directions, braking, moving forward, etc.) for the vehicle 403 through the ADAS of the vehicle 403.

In another embodiment, an autonomous entity monitoring system can generate a 3D scene based on the extrinsic calibration 350 that can assist the decision-making process of a decision-making entity. For example, in a traffic scene, the 3D scene can show the current traffic scene on a display. The 3D scene can be used by a trajectory generation module that can generate trajectories for a vehicle and aid the driving decisions (e.g., decision making process) of the driver (e.g., decision-making entity). In another embodiment, the 3D scene can be employed by road maintenance entities to determine the road conditions and severity of defects within the road based on the 3D scene and the extrinsic calibration 350.

The present embodiments can be employed to other fields such as public service, education, legal, finance, etc.

The present embodiments can establish an automated camera-LiDAR calibration framework that operates seamlessly with everyday driving data, proficiently estimating the extrinsic calibration parameters for a single LiDAR sensor and six surround-view cameras. Utilizing near-infrared image (NIR) captured by LiDAR to facilitate 2D-3D correspondences between the camera and LiDAR obviates the need for manual efforts in identifying correspondences, as well as the need for calibration targets such as checkboards. As such, the correspondences are also diverse as it can be any matched points in the scene. The inclusion of diverse correspondences in the optimization process improves overall robustness of the present embodiments over other calibration models. Furthermore, its automatic nature enables real-time online calibration through streaming data obtained from input sensors, a capability not achievable with target-based checkerboard calibration models.

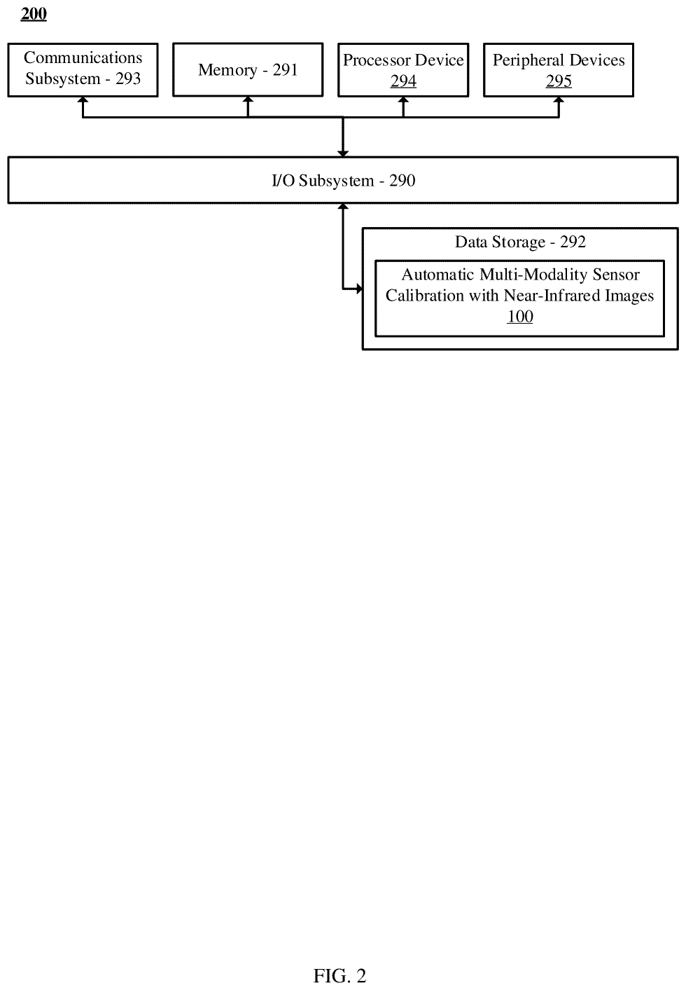

Referring now to FIG. 2, a system for automatic multi-modality sensor calibration with near-infrared images is illustratively depicted in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for automatic multi-modality sensor calibration with near-infrared images 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

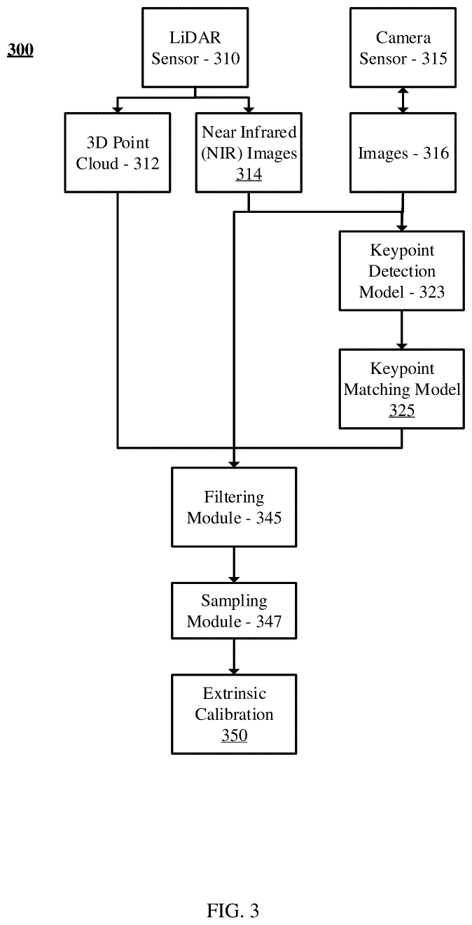

Referring now to FIG. 3, which describes an embodiment of an implementation using software and hardware components for automatic multi-modality sensor calibration.

In an embodiment, a method for automatic multi-modality sensor calibration with near-infrared images (NIR) can obtain an extrinsic calibration 350 for an autonomous entity control system 300. To obtain the extrinsic calibration 350, a convolutional neural network included in a keypoint detection model 323 can detect image keypoints from collected images 316 from a camera sensor 315, and NIR keypoints from NIR 314 obtained from a LiDAR Sensor 310.

A deep-learning-based neural network included in a keypoint matching model 325 that learns relation graphs between the image keypoints and the NIR keypoints can match the image keypoints and the NIR keypoints. Three dimensional (3D) points from 3D point cloud data can be filtered using a filtering module 345 based on corresponding 3D points from the NIR keypoints (NIR-to-3D points) to obtain filtered NIR-to-3D points. An extrinsic calibration can be optimized based on a reprojection error computed from the filtered NIR-to-3D points using a sampling module 347 that can implement RANSAC with PnP to obtain the optimized extrinsic calibration 350.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

The present embodiments can employ deep learning neural networks such as the keypoint detection model 323 and the keypoint matching model 325.

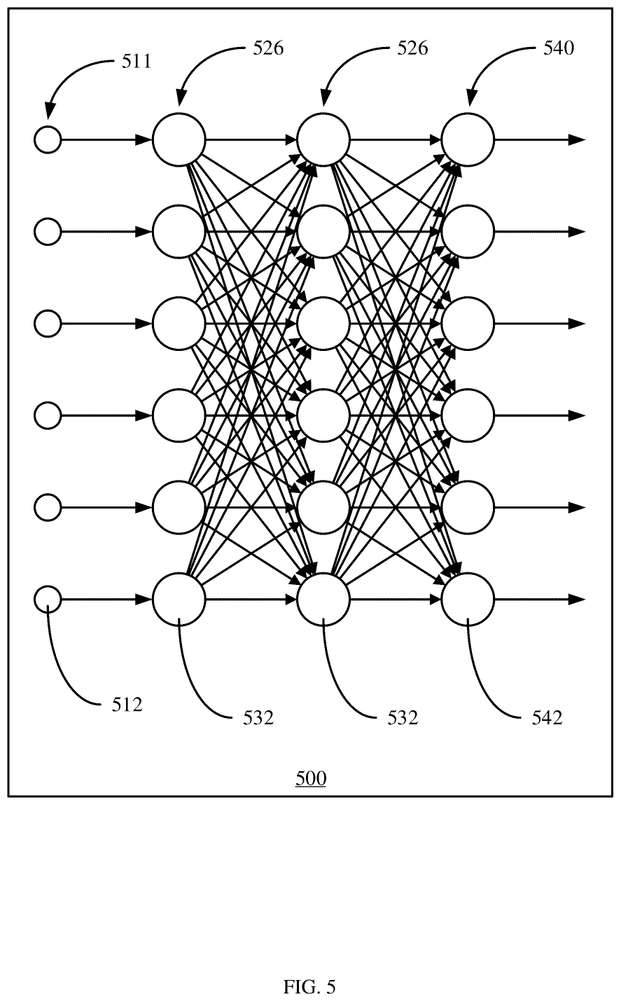

Referring now to FIG. 5, a block diagram illustrating deep learning neural networks for automatic multi-modality sensor calibration with near-infrared images, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . , wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the keypoint detection model 323 can learn relationships between points of interest of two input images (e.g., NIR images 314 and Images 316). The output layer 540 of the keypoint detection model 323can then provide the overall response of the network as a likelihood score of a point within the images as a keypoint. In another embodiment, the keypoint matching model 325 can identify associations between keypoints and generate associated keypoints.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for automatic multi-modality sensor calibration with near-infrared images (NIR), comprising:
detecting image keypoints from collected images and NIR keypoints from NIR;
matching the image keypoints and the NIR keypoints using a deep-learning-based neural network that learns relation graphs between the image keypoints and the NIR keypoints;
filtering three dimensional (3D) points from 3D point cloud data based on corresponding 3D points from the NIR keypoints (NIR-to-3D points) to obtain filtered NIR-to-3D points;
optimizing an extrinsic calibration based on a reprojection error computed from the filtered NIR-to-3D points to obtain an optimized extrinsic calibration for an autonomous entity control system; and
controlling an entity by employing the optimized extrinsic calibration for the autonomous entity control system.

2. The computer-implemented method of claim 1, wherein controlling the entity further comprises controlling an autonomous patient monitoring system to monitor patients within a hospital ward.

3. The computer-implemented method of claim 1, wherein controlling the entity further comprises controlling a vehicle based on the optimized extrinsic calibration.

4. The computer-implemented method of claim 1, wherein filtering the 3D points further comprises retaining NIR keypoints with corresponding 3D points from the 3D point cloud data.

5. The computer-implemented method of claim 1, wherein filtering the 3D points further comprises employing bilinear interpolation to approximate 3D points from sub-pixel keypoints from the NIR keypoints.

6. The computer-implemented method of claim 1, wherein optimizing the extrinsic calibration further comprises minimizing the reprojection error between projections of the filtered NIR-to-3D points to an image plane and their corresponding image keypoints using a perspective-n-point module that employs random sample consensus (RANSAC) outlier removal.

7. The computer-implemented method of claim 1, wherein optimizing the extrinsic calibration further comprises iteratively determining the extrinsic calibration that includes a highest number of data points between 3D points and two-dimensional (2D) points.

8. A system for automatic multi-modality sensor calibration with near-infrared images (NIR), comprising:
a memory device;
one or more processor devices operatively coupled with the memory device to:
detect image keypoints from collected images and NIR keypoints from NIR;
match the image keypoints and the NIR keypoints using a deep-learning-based neural network that learns relation graphs between the image keypoints and the NIR keypoints;
filter three dimensional (3D) points from 3D point cloud data based on corresponding 3D points from the NIR keypoints (NIR-to-3D points) to obtain filtered NIR-to-3D points;
optimize an extrinsic calibration based on a reprojection error computed from the filtered NIR-to-3D points to obtain an optimized extrinsic calibration for an autonomous entity control system; and
control an entity by employing the optimized extrinsic calibration for the autonomous entity control system.

9. The system of claim 8, wherein to control the entity further comprises controlling an autonomous patient monitoring system based on the extrinsic calibration to monitor patients within a hospital ward.

10. The system of claim 8, wherein to control the entity further comprises controlling a vehicle based on the extrinsic calibration.

11. The system of claim 8, wherein to filter the 3D points further comprises retaining NIR keypoints with corresponding 3D points from the 3D point cloud data.

12. The system of claim 8, wherein to filter the 3D points further comprises employing bilinear interpolation to approximate 3D points from sub-pixel keypoints from the NIR keypoints.

13. The system of claim 8, wherein to optimize the extrinsic calibration further comprises to minimize the reprojection error between projections of the filtered NIR-to-3D points to an image plane and their corresponding image keypoints using a perspective-n-point module that employs random sample consensus (RANSAC) outlier removal.

14. The system of claim 8, wherein to optimize the extrinsic calibration further comprises to iteratively determine the extrinsic calibration that includes a highest number of data points between 3D points and two-dimensional (2D) points.

15. A non-transitory computer program product comprising a computer-readable storage medium including program code for automatic multi-modality sensor calibration with near infrared images (NIR), wherein the program code when executed on a computer causes the computer to:
detect image keypoints from collected images and NIR keypoints from NIR;
match the image keypoints and the NIR keypoints using a deep-learning-based neural network that learns relation graphs between the image keypoints and the NIR keypoints;
filter three dimensional (3D) points from 3D point cloud data based on corresponding 3D points from the NIR keypoints (NIR-to-3D points) to obtain filtered NIR-to-3D points;
optimize an extrinsic calibration based on a reprojection error computed from the filtered NIR-to-3D points to obtain an optimized extrinsic calibration for an autonomous entity control system; and
control an entity by employing the optimized extrinsic calibration for the autonomous entity control system.

16. The non-transitory computer program product of claim 15, wherein to control the entity further comprises controlling an autonomous patient monitoring system based on the extrinsic calibration to monitor patients within a hospital ward.

17. The non-transitory computer program product of claim 15, wherein to filter the 3D points further comprises retaining NIR keypoints with corresponding 3D points from the 3D point cloud data.

18. The non-transitory computer program product of claim 15, wherein to filter the 3D points further comprises employing bilinear interpolation to approximate 3D points from sub-pixel keypoints from the NIR keypoints.

19. The non-transitory computer program product of claim 15, wherein to optimize the extrinsic calibration further comprises to minimize the reprojection error between projections of the filtered NIR-to-3D points to an image plane and their corresponding image keypoints using a perspective-n-point module that employs random sample consensus (RANSAC) outlier removal.

20. The non-transitory computer program product of claim 15, wherein to optimize the extrinsic calibration further comprises iteratively determining the extrinsic calibration that includes a highest number of data points between 3D points and two-dimensional (2D) points.
